(19) United States
(12) Patent Application Publication
(10) Pub. No.: US 2007/0261515 A1
(43) Pub. Date: Nov. 15, 2007

(54) Bicycle bottom bracket axle, bearing assembly and crank mounting arrangement

(76) Inventor: Earle Holderman Jones, Issaquah, WA (US)

Correspondence Address: EARLE H. JONES, 410 MT JUPITER DR SW, ISSAQUAH, WA, 98027, US

(21) Appl. No.: 11/434,011

(22) Filed: May 15, 2006

(51) Int. Cl. G05G 1/14

(52) U.S. Cl. 74/594.1

(57) ABSTRACT

Referring to FIG. 4 a bottom bracket axle and crank mounting system includes a bottom bracket axle 34 inserted through a bottom bracket 33, two ball bearing assemblies 35 mounted on the axle 34 with the outer races of the ball bearing assemblies 35 mounted in a bored shoulder hole provided in the outer ends of the of the bottom bracket 33. Disk springs 36 are mounted outside of each left and right ball bearing assemblies 35 and the left crank 30 and right crank and sprocket assembly 31 are mounted outside of the disk spring washers. The left crank 30 and right crank and sprocket assembly 31 are secured with the correct torque to the axle with axle bolts 32 which secure the complete assembly. When tightening the axle bolts 32, the cranks 30 and 31 are both secured to the axle 34 and the disk springs 36 being deflected at the same time, provide thrust loading to the bearings 35 and thereby securing and stabilizing the complete assembly.

### CROSS REFERENCE TO RELATED APPLICATIONS

### US Patent Document

| | | | |
|---|---|---|---|
| 3,578,829 | November 1969 | HATA | 308/179; 74; 594 |
| 5,181,437 | July 1992 | CHI | 74/584; 384/545 |
| 6,474,192 | March 2001 | LIN | 74/594; 384/540 |
| 5,437,510 | March 1994 | JENG | 384/538; 384/540 |
| 5,572,909 | January 1994 | CHI | 74/594; 384/458 |

### BACKGROUND AND SUMMARY OF THE INVENTION

The present invention relates to bicycles and more specifically to an assembly which consists of a bottom bracket axle, two sealed and self lubricated ball bearing assemblies, a bottom bracket, a required amount of disk spring washers, a left bicycle crank, a right bicycle crank and sprocket assembly and two axle bolts to secure and stabilize the complete assembly to the bicycle. The present invention has been accomplished to provide a sealed bottom bracket bearing that requires no adjustment and has much greater radial and thrust load capability than most prior bearings. The problems related to the inner thread at each of the two ends of the bottom bracket has been removed by simply boring a bearing seat at the two ends of the bottom bracket to support the bearing assemblies. The two standard axle bolts, when tightened to the proper torque accomplish the following: they force the cranks onto the axle, deflect the disk spring washers which provide lateral thrust to the ball bearings, all of which fix the complete assembly in place. Both time of assembly, cost of components, and weight of components have been improved by the present invention.

A regular bicycle comprises a bottom bracket bearing axle or cartridge, mounted by threads in a bottom bracket and additional two axle bolts to hold left and right cranks and pedal assemblies for pedaling.

### BRIEF DESCRIPTION OF DRAWINGS

FIG. 1 is a sectional view of a bottom bracket bearing axle mounting system according to prior art.

FIG. 2 is a sectional view of a bottom bracket bearing axle mounting system according to prior art.

FIG. 3 is a sectional view of a bottom bracket bearing axle mounting system according to prior art.

FIG. 4 is a sectional view of the present invention.

### DETAILED DESCRIPTION OF PRIOR ART

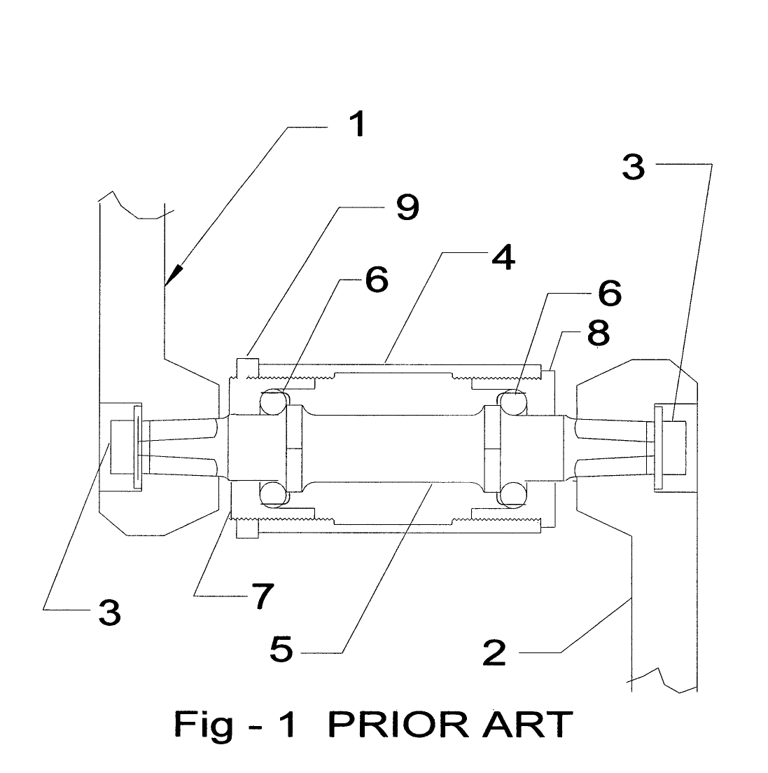

FIG. 1 shows a bottom bracket bearing axle mounting arrangement according to prior art. As illustrated in FIG. 1 a bottom bracket bearing axle 5, is inserted through a bottom bracket 4, then two sets of steel ball assemblies 6, are mounted around bearing seats which are integral to the bottom bracket bearing axle 5. A right threaded outer bearing race 8, is then threaded into the right side of the bottom bracket 4, and a left threaded outer bearing race 7, is threaded into the left side of the bottom bracket 4. The lock ring 9, is then tightened to lock the assembly. The left crank 1, is then placed over the left end of the axle 5, and the axle bolt 3, is then tightened to the correct torque, The right crank-sprocket assembly 2, is then placed over the right end of the axle 5 and the axle bolt 3, is then tightened to the correct torque.

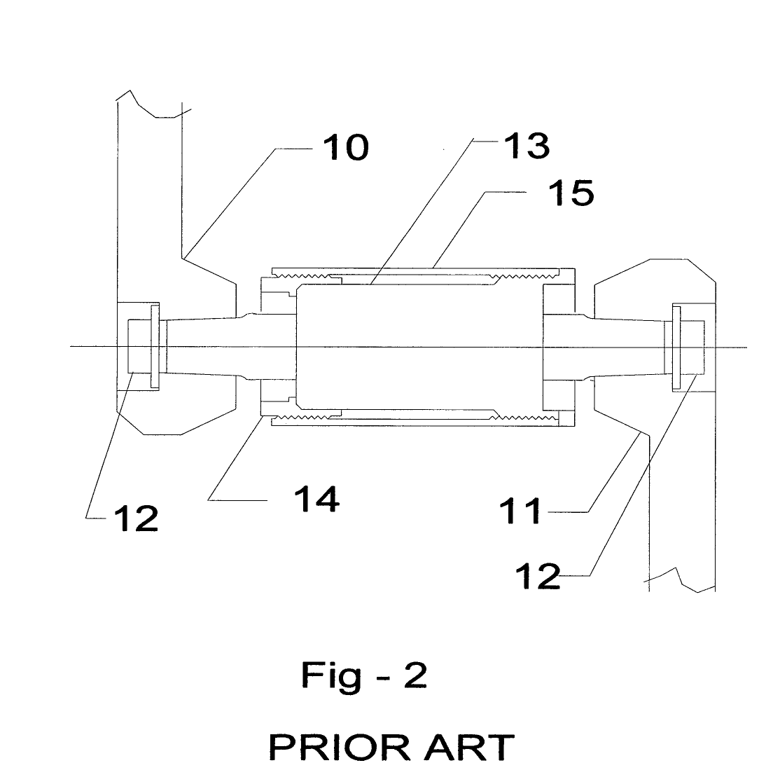

FIG. 2 shows a bottom bracket bearing cartridge arrangement according to prior art as illustrated. FIG. 2 shows a bottom bearing cartridge assembly 13, which is threaded into the right side of the bottom bracket 15. The locking ring 14 is then threaded into the left end of the bottom bracket 15. The left crank is 10 then placed over the mating end of the bearing cartridge assembly 13, and the axle bolt 12 is then tightened to the correct torque. The right crank-sprocket assembly 11, is placed over the right mating end of the bearing cartridge assembly 13 and the axle bolt 12 is then tightened to the correct torque.

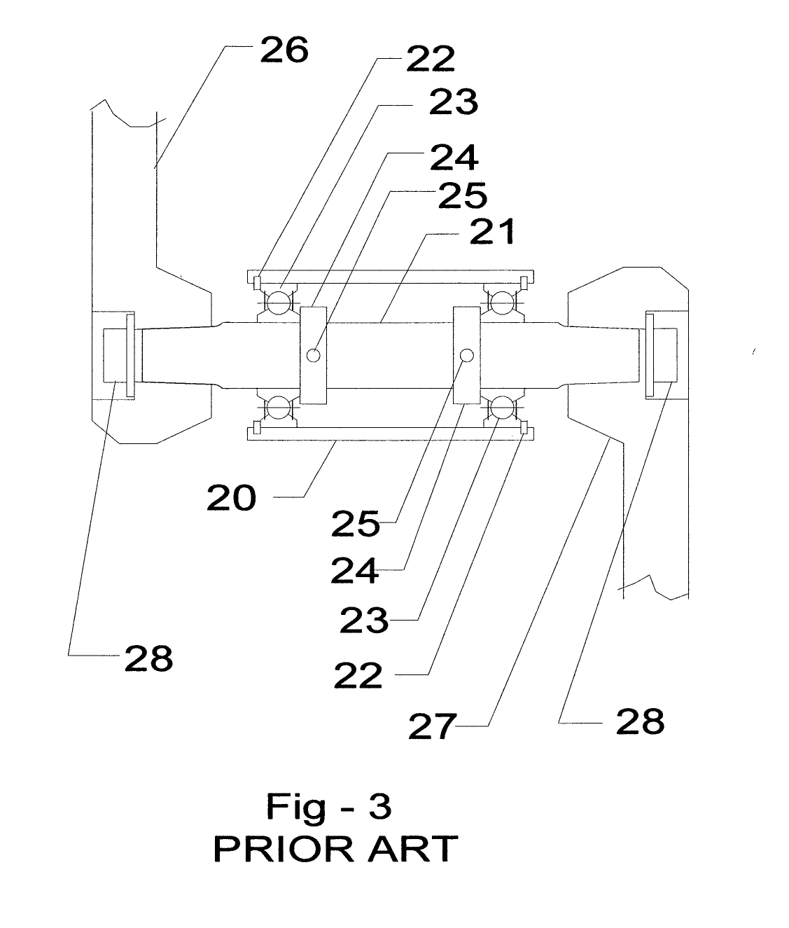

FIG. 3 shows a bottom bracket bearing axle mounting arrangement according to prior art. As illustrated in FIG. 3, a bottom bracket bearing axle 21, is inserted through a bottom bracket 20, then two sets of positioning rings 24 and position locking set screws 25 are placed around the periphery of the axle 21 in the correct position. Two ball bearing assemblies 23, are then mounted around the periphery and on each side of the axle 21 against the positioning rings 24 and inside the bottom bracket 20 as shown. Snap rings 22 are then inserted in the ends of the bottom bracket 20 to secure the axle in position. The left crank 26 is then placed over the left end of the axle 21, and the axle bolt 28, is then tightened to the correct torque. The right crank-sprocket assembly 27. is then placed over the right end of the axle 21 and the axle bolt 28, is then tightened to the correct torque. The correct positioning of all components will be required to prevent lateral movement in the axle 21 and the cranks 26 and 27 and this could prove to be difficult.

### DETAILED DESCRIPTION OF THE PREFERRED EMBODIMENT

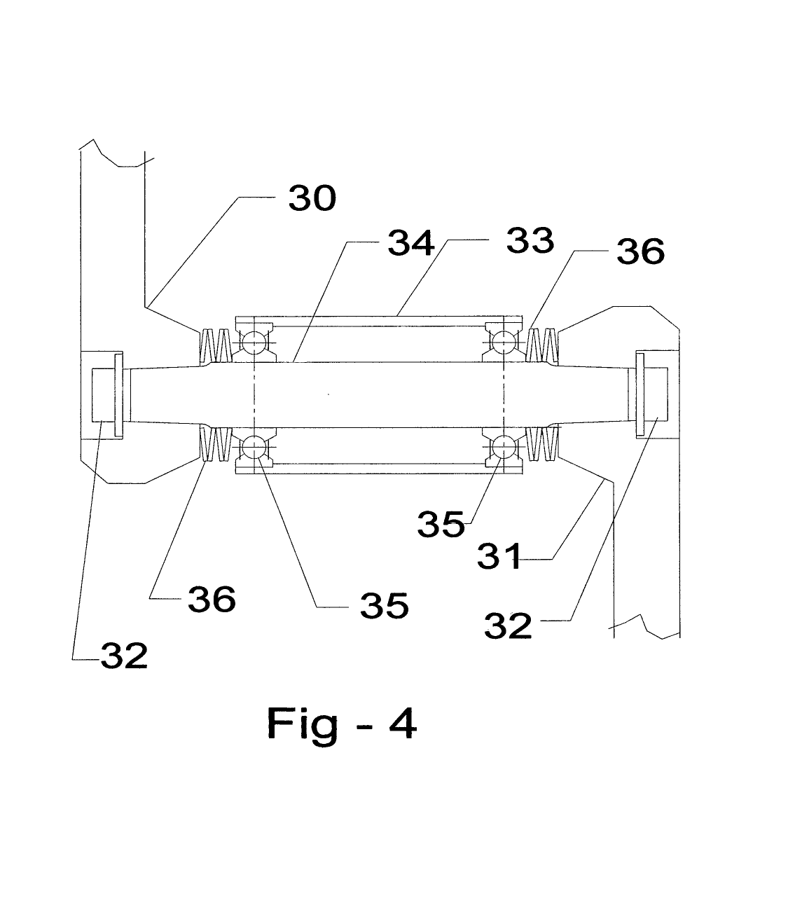

Referring to FIG. 4, the present invention comprises of a bottom bracket 33, a bottom bracket axle 34, inserted through the bottom bracket 33, two ball bearing assemblies 35 of which the inner race is placed around the periphery of the bottom bracket axle 34, the outer race of the bearing assembly 35, is seated in the bearing seats at the two ends of the bottom bracket 33. The disk springs 36, are mounted around the periphery of the bottom bracket axle 34 adjacent and outside of the bearing assemblies 35. The quantity and location of the disk springs 36 is determined by the relationship of the structure of the other components of the assembly. The left crank 30, is then placed over the left end of bottom bracket axle 10 and the right crank-sprocket assembly 31, is placed over the right end of the bottom bracket axle 34. The two axle bolts 32, are then threaded into the two ends of the bottom bracket axle 34 and tightened as required by bicycle specifications. The resulting torque secures the cranks 31 and 32 and also with the deflecting of the disk springs 36, secures and stabilizes the entire assembly.

While only one embodiment of the present invention has been shown and described, it will be understood that various modifications and changes could be made thereunto without departing from the spirit and scope of the invention disclosed.

### BACKGROUND AND SUMMARY OF MY INVENTION

The present invention relates to bicycles and more specifically to an assembly which consists of a bottom bracket axle, two sealed and self lubricated ball bearing assemblies, a bottom bracket, a required amount of disk spring washers, a left bicycle crank, a right bicycle crank-sprocket assembly and two axle bolts to secure and stabilize the complete assembly to the bicycle. The present invention has been accomplished to provide a sealed bottom bracket bearing that requires no adjustment and has much greater radial and thrust load capability than prior art. The problem of the inner thread at each of the two ends of the bottom bracket has been eliminated by simply boring a bearing seat at the two ends of the bottom bracket to support the bearing assemblies. The two standard axle bolts, when tightened to the proper torque accomplish the following: they position the cranks onto the axle, deflect the disk spring washers which provide lateral thrust to the ball bearings, all of which fix the complete assembly in place. Both time of assembly, cost of components, and weight of components have been improved by the present invention. The complete assembly can be removed from the bicycle by the removal of one axle bolt and one crank.

A regular bicycle comprises a bottom bracket bearing axle or cartridge, mounted by threads in a bottom bracket and additional two axle bolts to hold left and right cranks and pedal assemblies for pedaling.

I claim as my invention:

1. A bicycle pedal crank mounting arrangement that secures the bottom bracket axle, the bottom bracket bearing, disk spring washers and left and right cranks secured with two axle bolts comprising:
a) A bottom bracket with machine counter bored in each end to seat a ball bearing assembly
b) Ball bearing assemblies seated in each end of the bottom bracket.
c) A bracket axle inserted through said ball bearing assemblies.
d) A required amount of disk spring washers, mounted in series on the axle adjacent to both left and right ball bearing assemblies.
e) A left crank mounted on the left side of the assembly and a right crank sprocket assembly mounted on the right side of the assembly.
f) An axle bolt mounted on each end of the bottom bracket axle and tightened to the correct torque.

2. A bicycle pedal crank mounting arrangement of claim 1 wherein no threads are required in the bottom bracket but are replaced with a machined counter bore diameter at each end of the bottom bracket shell to support the ball bearing assembly. The bottom bracket shell counter bore supports the outer race of the bottom bracket bearing and defines the axial position of the bottom bracket bearing

3. A bicycle pedal crank mounting arrangement of claim 1 wherein the bottom bracket axle is not part of the bottom bracket bearing. The bottom bracket axle is inserted in the two bottom bracket bearings inner race which does not restrict the axial movement of the axle.

4. A bicycle pedal crank mounting arrangement of claim 1 wherein the spring disk washers stabilize and determine the position of the left crank and right crank sprocket assembly and the bottom bracket axle. By choosing the location of the spring disks, equal or unequal quantities on the left and right side, the lateral position of the cranks can be adjusted to a desired position of the cranks.

5. A bicycle pedal crank mounting arrangement of claim 1 wherein the two cranks, the axle, the bearing assemblies and the disk spring washers can all be secured and stabilized with the two axle bolts. The required axial movement of the cranks to lock them to the axle also deflects the spring disk washers providing spring loaded thrust to hold the bearings in place and stabilizes the complete assembly in a fixed position.
